(19) United States
(12) Patent Application Publication
(10) Pub. No.: US 2013/0344216 A1
(43) Pub. Date: Dec. 26, 2013

(54) ERYTHRITOL COCRYSTALS AND METHOD OF MAKING SAME

(71) Applicant: ZIBO ZHONGSHI GREEN BIOTECH CO., LTD., Zibi City (CN)

(72) Inventors: Tinggang Wang, Zibo City (CN); Yi Han, Qingdao City (CN)

(73) Assignee: ZIBO ZHONGSHI GREEN BIOTECH CO., LTD., Zibo City (CN)

(21) Appl. No.: 13/836,740

(22) Filed: Mar. 15, 2013

(30) Foreign Application Priority Data
Jun. 21, 2012 (CN) PCT/CN2012/000085

(51) Int. Cl. A23L 1/236

(52) U.S. Cl. CPC A23L 1/2364
USPC 426/548

(57) ABSTRACT

Cocrystals of erythritol and a higher sweetener, and a method of making same, are provided. The high sweetener is a natural or synthetic sweetener having a sweetness greater than that of sucrose. The cocrystals are formed by preparing a supersaturated erythritol solution having a degree of supersaturation of from 1.1 to 1.5 and an erythritol mass concentration of from 70 to 95% or higher; forming a sweetened solution by adding a high sweetener to the supersaturated erythritol solution; and forming cocrystals of erythritol and the high sweetener by cooling the sweetened solution. The preferred mass proportion of erythritol to high sweetener of from 100:0.1 to 100:5.

### CROSS-REFERENCE TO RELATED APPLICATION

This application is a continuation-in-part of International Application No. PCT/CN2012/000855, filed Jun. 21, 2012 in the Chinese Patent Office. Foreign priority is claimed under 35 U.S.C. §119.

### FIELD OF THE INVENTION

The present invention relates to sweeteners containing erythritol and a method of boosting the sweetness of erythritol using cocrystallization.

### DESCRIPTION OF THE RELATED ART

Erythritol is a natural sugar alcohol that has been approved as a food additive throughout most of the world. It is the only non-caloric sugar alcohol. Although its sweetness is about 70% of that of sucrose, erythritol has a refreshing taste and it is used as a non-caloric sugar substitute in many food products. It is an excellent alternative to sucrose and xylitol. Erythritol des not promote tooth decay or blood-glucose fluctuation, and it has superior processing characteristics, including being non-moisture-absorbing and resistant to browning at elevated temperature.

Two drawbacks of erythritol are low sweetness and low solubility in cold water. People have long sought to increase the sweetness of erythritol by compounding or coating it with other sweeteners. Such techniques have met with limited success, however, due to lack of uniformity of the resulting product and content stability issues. Lack of homogeneity is particularly a problem with small quantities of modified erythritol.

A number of sucrose alternatives have been described in the art, including water-dispersible, “instant,” and protein-entrained sucrose cocrystals and other cocrystalline sugar products. However, these generally have relied on sucrose or some other sugar as a primary component or carrier (i.e., a carrier for food or pharmaceutical ingredients), typically in order to address problems involving the use or storage of a particular food or pharmaceutical product. A definite need exists for an improved erythritol sweetener having uniform sweetness and stable content, and a simple method of making same.

### SUMMARY OF THE INVENTION

In one aspect, the invention provides an improved erythritol sweetener prepared by cocrystallizing erythritol with one or more natural or synthetic sweeteners, referred to herein as “high sweeteners.” In another aspect, the invention provides a method of boosting the sweetness of erythritol, the method comprising the steps of preparing a supersaturated erythritol solution having a degree of supersaturation of from 1.1 to 1.5 and an erythritol mass concentration of from 70 to 95% or higher; forming a sweetened solution by adding a high sweetener to the supersaturated erythritol solution; and forming cocrystals of erythritol and the high sweetener by cooling the sweetened solution.

### DETAILED DESCRIPTION

The invention provides cocrystals of erythritol and a “high sweetener.” By “high sweetener” is meant a natural or synthetic sweetener having a sweetness greater than that of sucrose. Nonlimiting examples of natural sweeteners, which are typically derived from plants, include fructose (1.7 or 1.8 times sweeter than sucrose), glycyrrhizin (30-50 times as sweet as sucrose), thaumatin (as much as 2000 times as sweet as sucrose), monellin (800-2000 times sweeter than sucrose), mogrosides, derived from monk fruit (siraitia grosvenorii, nearly 300 times sweeter than sucrose), and steviol glycosides, derived from the stevia plant (40-300 times sweeter than sucrose). Within a given class, certain glycosides are sweeter than others and are employed preferentially in some embodiments. For example, Rebaudioside A (“Reb A”) is a particularly preferred stevioside due to its sweetness and low bitterness. In one embodiment, a steviol sweetener containing more than 97% by weight Reb A is used as the high sweetener.

Nonlimiting examples of synthetic sweeteners include sucralose (˜600 times as sweet as sucrose), acesulfame potassium (AK sugar, 200 times sweeter than sucrose), aspartyl alaninamide (alitame, ˜2000 times sweeter than sucrose), and aspartame (˜200 times sweeter than sucrose). It is preferred to employ only those sweeteners that are generally recognized as safe (GRAS).

Individual sweeteners or mixtures of sweeteners can be employed as the high sweetener. The preferred proportions of erythritol to high sweetener range from 100:0.5 to 100:5.0 parts by weight.

Cocrystals of erythritol and a high sweetener are conveniently prepared by the following method. First, a supersaturated solution of erythritol is prepared in a conventional way, e.g., by preparing a saturated solution, increasing the temperature, and adding additional erythritol and causing it to dissolve. Second, a sweetened solution is prepared by adding a desired quantity of high sweetener (which can be a single sweetener or a mixture of sweeteners) to the supersaturated solution and causing it to dissolve therein. Third, erythritol/high sweetener cocrystals are formed by slowly cooling the sweetened solution, preferably with gentle stirring. Cooling is accomplished with or without an external cooling source, such as an ice bath, cold water jacket, etc.

By weight, the supersaturated solution preferably contains 70-95% (or higher) erythritol and has a degree of supersaturation of 1.1 to 1.5. By “degree of supersaturation” is meant the ratio of the observed solubility of erythritol for the supersaturated solution to the equilibrium solubility of erythritol at a given temperature and pressure.

If the latent heat released during spontaneous cocrystallization is insufficient to dry the cocrystals, they can be dried in air at 40-60° C. Preferably, the moisture content of the dried crystals is less than 0.2% by weight. The dried crystals can be sieved to a desired particle size, e.g., 16-60 mesh.

The cocrystalline erythritol/high sweetener has uniform sweetness, stable erythritol content, and fine crystallinity.

The following examples further illustrate the invention. All solutions are aqueous solutions.

### Embodiment 1

Cocrystals of erythritol and mogrosides (monk fruit extract), having a sweetness the same as sucrose.

Monk fruit extract (S. grosvenorii) with mogroside content at 40% (w/w) and 300 times as sweet as sucrose is used as the high sweetener. As a sweetness the same as sucrose is desired for the end product, the mass ratio of high sweetener to erythritol is 1:1000. Take 1000 g of erythritol and prepare an 80% (w/w) erythritol solution. Heat the solution to 90° C. and then cool it by 6° C./hour. Add 1 g of monk fruit extract when the supersaturation reaches 1.2. Stir and continue to cool by 10° C./hour until the solution reaches 30° C. Without further drying, the moisture content of the cocrystals thus formed is 0.12%. Separate the cocrystals with a 16-60 mesh standard sieve to obtain the cocrystalline product. The product can be used as a substitute for sucrose and has monk fruit flavor and health benefits.

### Embodiment 2

Cocrystals of erythritol and sucralose, having a sweetness twice that of sucrose.

Sucralose is 600 times as sweet as sucrose. As a sweetness twice that of sucrose is desired, the mass ratio of sucralose to erythritol is 2.2:1000. Take 1000 g of erythritol and prepare a 90% (w/w) erythritol solution. Heat the solution to 110° C. and then cool it by 6° C./hour until the solution reaches 30° C. Without further drying, the moisture content of the product is 0.09%, and the product is transparent and smooth. Separate with a 16-60 mesh standard sieve to obtain the cocrystalline product, which has a pure taste and can be used as a sucrose substitute.

### Embodiment 3

Cocrystals of stevioside and erythritol based on a ratio of 1:1000, with a sweetness the same as sucrose.

Take 500 g of erythritol and prepare an 85% (w/w) erythritol solution. Heat the solution to 95° C. and then cool it by 5° C./hour. Add 0.5 g of stevioside, Rebaudioside A (>97% by weight) when the supersaturation reaches 1.1. Stir and continue to cool by 8° C./hour until the solution reaches 30° C. Without further drying, the moisture content is 0.1%. Separate with a 16-60 mesh standard sieve to obtain the cocrystalline product. The product is 100% natural, non-caloric, and can be used as a substitute for sucrose, with the same sweetness.

### Embodiment b 4

Cocrystals of fructose and erythritol, with a sweetness the same as sucrose.

Fructose is ˜1.8 times as sweet as sucrose. As the final product is to have a sweetness the same as sucrose, the mass ratio of fructose to sucrose is 17.6:100. Take 1000 g of erythritol and prepare a 70% (w/w) erythritol solution. Heat the solution to 90° C. and add 176 g of fructose. After the fructose dissolves, cool the solution by 5° C./hour. When the temperature reaches 68° C., natural crystallization occurs. Stir and continue to cool until the solution reaches 30° C. Dry at 50° C. for one hour. The moisture content is 0.07%. Separate with a 16-60 mesh standard sieve to obtain the cocrystalline product. The product has a pure fructose flavor and will not cause an increase in GI value of blood glucose. It is an ideal sugar product for patients with diabetes.

The invention has been described with various embodiments and features, but is not limited thereto. Modifications can be made within the scope of the invention, which is limited only by the appended claims and their equivalents.

What is claimed is:

1. A method of preparing erythritol cocrystals, comprising:
preparing a supersaturated erythritol solution having a degree of supersaturation of from 1.1 to 1.5 and an erythritol mass concentration of from 70 to 95%;
forming a sweetened solution by adding a high sweetener to the supersaturated erythritol solution; and
forming cocrystals of erythritol and the high sweetener by cooling the sweetened solution.

2. The method according to claim 1, wherein the supersaturated erythritol solution is prepared by heating an erythritol solution above its saturation temperature under atmospheric pressure, additional erythritol to the solution, and then cooling the solution to obtain the supersaturated erythritol solution.

3. The method according to claim 1, wherein the erythritol solution is cooled slowly to achieve the degree of supersaturation.

4. The method according to claim 1, wherein the sweetened solution has a mass proportion of erythritol to high sweetener of from 100:0.1 to 100:5.

5. The method according to claim 1, wherein the high sweetener is selected from the group consisting of fructose, glycyrrhizin, thaumatin, monellin, mogrosides, and steviol glycosides.

6. The method according to claim 1, wherein the high sweetener is selected from the group consisting of sucralose, acesulfame potassium, aspartyl alaninamide, and aspartame.

7. The method according to claim 1, wherein the high sweetener contains more than one compound.

8. The method according to claim 1, wherein the high sweetener comprises two or more sweeteners.

9. The method according to claim 1, wherein the cocrystals have a moisture content of less than 0.2 wt %.

10. The method according to claim 1, further comprising drying the cocrystals.

11. The method according to claim 10, wherein the cocrystals are dried by heating them at a temperature of from 40-60° C.

12. The method according to claim 1, further comprising separating at least some of the cocrystals by passing them through a sieve.

13. The method according to claim 12, wherein the sieve has a size of from 16 to 60 mesh.

14. Erythritol cocrystals, comprising:
erythritol cocrystallized with a high sweetener selected from the group consisting of fructose, glycyrrhizin, thaumatin, monellin, mogrosides, and steviol glycosides.

15. The erythritol cocrystals according to claim 14, having a mass proportion of erythritol to high sweetener of from 100:0.1 to 100:5.

16. Erythritol cocrystals, comprising:
erythritol cocrystallized with a high sweetener selected from the group consisting of sucralose, acesulfame potassium, aspartyl alaninamide, and aspartame.

17. The erythritol cocrystals according to claim 16, having a mass proportion of erythritol to high sweetener of from 100:0.1 to 100:5.

18. Erythritol cocrystals, comprising:
erythritol cocrystallized with a high sweetener selected from the group consisting of fructose, glycyrrhizin, thaumatin, monellin, mogrosides, steviol glycosides, sucralose, acesulfame potassium, aspartyl alaninamide, aspartame, and mixtures thereof.

19. The erythritol cocrystals according to claim 18, having a mass proportion of erythritol to high sweetener of from 100:0.1 to 100:5.

20. Erythritol cocrystals, prepared by the process of:
preparing a supersaturated erythritol solution having a degree of supersaturation of from 1.1 to 1.5 and an erythritol mass concentration of from 70 to 95%;
forming a sweetened solution by adding a high sweetener to the supersaturated erythritol solution; and
forming cocrystals of erythritol and the high sweetener by cooling the sweetened solution.

21. The erythritol cocrystals according to claim 20, wherein the sweetened solution has a mass proportion of erythritol to high sweetener of from 100:0.1 to 100:5.
